(19) United States
(12) Patent Application Publication
(10) Pub. No.: US 2004/0193735 A1
(43) Pub. Date: Sep. 30, 2004

(54) Method and circuit arrangement for synchronization of synchronously or asynchronously clocked processor units

(76) Inventors: Pavel Peleska, Grafelfing (DE); Dirk Schnabel, Munchen (DE); Anton Weber, Munchen (DE)

Correspondence Address: MORRISON & FOERSTER LLP, 1650 TYSONS BOULEVARD, SUITE 300, MCLEAN, VA, 22102, US

(21) Appl. No.: 10/659,701

(22) Filed: Sep. 11, 2003

Related U.S. Application Data
(60) Provisional application No. 60/432,671, filed on Dec. 12, 2002.

(30) Foreign Application Priority Data
Sep. 12, 2002 (EP) 02020602.5
Dec. 12, 2002 (EP) 02027847.9

(51) Int. Cl. G06F 1/12

(52) U.S. Cl. 709/400

(57) ABSTRACT

A method implemented in hardware for synchronization of identical or different redundant processing units which process identical instruction sequences and are synchronously or asynchronously clocked. In the method, transactions that are external to the processing unit are used by modules assigned to the processing unit for synchronization of the processing unit in that the processing unit is delayed, in each case, by the assigned modules until the instruction execution of the processing units has reached the current transaction.

### CLAIM FOR PRIORITY

This application claims the benefit of priority to European Applications EP 02020602.5, filed Sep. 12, 2002, and EP 02027847.9, filed Dec. 12, 2002, which were filed in the German language, and to U.S. Provisional Application No. 60/432,671, filed Dec. 12, 2002, which was also filed in the German language.

### TECHNICAL FIELD OF THE INVENTION

The present invention relates to a system and method for synchronization of synchronously or asynchronously clocked processor units.

### BACKGROUND OF THE INVENTION

In telecommunications systems, in Data Centers and other high-availability systems, up to several hundred processor boards are used to provide the necessary processing power. This type of processor board typically consists of a processor or CPU (Central Processing Unit), a chip set, random access memory and peripheral components.

The likelihood that a hardware defect will occur in a typical processor board within any given year is a single-digit percentage figure. Because of the large number of processor boards combined to form a system, there is a very great likelihood of one of the hardware components failing within the one-year period, in which case a single failure of this nature can, unless adequate precautions are taken, lead to a failure of the entire system.

Telecommunications systems, and increasingly Data Centers, are now subject to demands for high availability. This is for example expressed as a percentage or the maximum permitted downtime per annum is specified. Typical requirements are for example an availability rate of >99.999% or a non-availability rate of a few periods of 10 minutes per year at most. Since changing a processor board and restoration of the service in the case of a hardware defect normally takes some time, ranging from 10 minutes or so up to several hours, the corresponding precautions must be taken for the case of a hardware defect at system level to enable to demand for system availability to be fulfilled.

Known solutions for maintaining these types of high system availability requirements make provision for redundant system components. The known methods can be subdivided into two main groups: software-based methods and hardware-based methods.

Software-based methods typically use middleware. Software-based solutions, however, are typically not very flexible since only the (application) software that was developed for this particular redundancy scheme can be used in such a system. This significantly reduces the range of (application) software that can be used. In addition, the application software for software redundancy principles is extremely expensive to develop in practice, whereby the development also brings with it a complicated test procedure.

The basic principle of hardware-based methods rests on encapsulating redundancy at a hardware level such that it is transparent for the software. A major advantage of redundancy which is managed by the hardware is that the application software is not affected by the redundancy principle and thereby in most cases any given software can be used.

One principle that is encountered frequently in practice for hardware fault tolerant systems for which redundancy is transparent for the software is what is known as the lockstep principle. Lockstep means that identically constructed hardware, e.g. two boards, are operated simultaneously with synchronized timing. Hardware mechanisms are used to ensure that the redundant hardware experiences identical input stimuli at a given point in time and must therefore arrive at identical results. The results of the redundant components are compared, and a fault is determined if there is a discrepancy and suitable measures are initiated (sending of alarms to operators, partial or complete safety shutdown, system restart).

The underlying requirement for the implementation of a lock-step system is the clocked deterministic behavior of all the components contained in the board, i.e. CPUs, chip sets, main memory etc. In this case, clocked deterministic behavior means that, if they are not faulty, the components will return identical results at identical points in time when the components receive identical stimuli at identical timing points. Clocked deterministic behavior also requires the use of synchronous timing interfaces. Asynchronous interfaces cause a degree of imprecise timing in many cases, in which case the clock synchronous overall behavior of the system cannot be maintained.

However, it is precisely for chip sets and CPUs that asynchronous interfaces offer technological benefits in increasing performance, which makes a clock-synchronous operating mode in accordance with the lockstep procedure impossible. In addition, modern CPUs increasingly use mechanisms that make a clock-synchronous operating mode impossible. These are for example internal correction measures not visible to the outside world, e.g. correction of an internal correctable error for access to a cache memory which can lead to a slight delay in instruction processing, or the speculative execution of commands. A further example is the increasing implementation in the future of CPU-internal clock-free execution units which provide significant benefits as regards speed and power dissipation but prevent clock-synchronous or deterministic operation of the CPU.

A functional lockstep arrangement for redundant processors is disclosed in U.S. Pat. No. 5,226,152 in which the processors are connected to a logic which synchronizes the access by the processors to the shared periphery and makes possible a functional lockstep operation of the redundant processors. In this case, the logic uses the wait signal of the processors.

With regard to the processor boards mentioned above, this arrangement, which features a single central logic, has one significant disadvantage, which is that in addition to the processor boards a logic board which then controls the synchronization of the peripheral accesses has to be provided for a specific number of processor boards. These logic boards must then be monitored in their turn, which would lead to complex monitoring mechanisms.

In other words, while the arrangement in accordance with U.S. Pat. No. 5,226,152 seems suitable for providing a functional lockstep for single-board systems with a number of processors, this arrangement is not suitable for systems with a number of similar or identical processor boards of the type mentioned at the start.

### SUMMARY OF THE INVENTION

The present invention specifies a procedure which preserves the advantages of the lockstep method and which takes account of technological development.

In one embodiment of the invention, there is a method provided for synchronization of identical or different, redundant processing units PRO₀, PRO₁ which process identical instruction sequences and are synchronously or asynchronously clocked, in accordance with which transactions that are external to the processing units PRO₀, PRO₁ are used by modules EQ₀, EQ₁ assigned to processing units PRO₀, PRO₁ for synchronization of the processing units PRO₀, PRO₁ with the processing units being delayed by the assigned modules and thereby synchronized until the instruction execution of all processing units has reached the current transaction.

In this case, the following transactions can be used for synchronization:

non-cacheable memory transactions relating to a local memory MEM₀, MEM₁ assigned to the relevant processing units PRO₀, PRO₁ and/or

input/output transactions for input/output modules I/O₀, I/O₁, and/or

memory-mapped input/output transactions for external registers REG₀, REG₁ and/or

non-cacheable memory transactions relating to a common memory CMEM of processing units PRO₀, PRO₁.

Read transactions can be executed in this case by the module assigned to a processing unit leaving the processing unit in the wait state until the data to be read arrives and sending the parameter or parameters of the read transaction to the module linked most directly to the transaction destination I/O₀, I/O₁, MEM₀, MEM₁, REG₀, REG₁, CMEM, whereby the module linked most directly to the transaction destination receives and compares the parameter or parameters of the other modules as well as the locally created parameters and, if they match, executes the read transaction and distributes the read data to the modules, whereafter the modules forward the read data to the assigned processing units and enable instruction processing to be continued.

Write transactions can be executed by the module assigned to a processing unit leaving the processing unit in the wait state until the write process is concluded and sending the parameter or parameters of the write transaction to the module linked most directly with the transaction destination I/O₀, I/O₁, MEM₀, MEM₁, REG₀, REG₁, CMEM, whereby the module most directly connected to the transaction destination receives and compares the parameter or parameters of the other modules as well as the parameter or parameters created locally and executes the write transaction if they match and acknowledges the completion of the write process to all modules, whereafter the modules enable the instruction execution of the assigned processing units to be continued.

Advantageously, external events, e.g. interrupts, can be handled in conjunction with the transaction-based synchronization method in accordance with the invention if the handling of the external events is initiated through the reading of a value, e.g. an interrupt vector, from a memory location or a register and it is also ensured that the processing units are presented with the external events at the same point in instruction execution. The read transaction initiating event handling is executed as described above, e.g. by means of an Interrupt Acknowledge Cycle.

A suitable method of synchronization of external events is described in European Patent Application 02020602 and makes provision for the external events to be buffered, whereby the stored external events are called in a special operating mode of the processing units for processing by at least one execution unit of the processing units and whereby the processing units in this operating mode come in response to the fulfillment of a condition that can be pre-specified by commands or is fixed and the continuation of instruction execution by the modules EQ₀, EQ₁ is delayed until the processing units have ended the special operating mode.

The changeover to the special operating mode is, for example, made if a match is determined by comparator elements K of the processing units between counter elements CIC and register elements MIR, whereby the content of register elements MIR can be pre-specified by commands and is identical for the processing units PRO₀, PRO₁ and the count element CIC includes the number of instructions executed by the execution units since the last change into the special operating mode.

Error handling can be initiated if the module linked most directly with the transaction destination establishes a deviation of the parameters of the other modules as well as of the locally created parameter(s). In this case, error handling can stop the transaction to be executed and start a routine for diagnosis, fault isolation and if necessary restoring synchronicity. If N (e.g. N=3) processing units are available, a one (N−1) of N majority decision of generally an (N−M) of N majority decision can be made and the deviating processing unit(s) can be deactivated.

Failure detection can also be undertaken for individual processing units, in which, for any given transaction, beginning with the earliest availability of the parameter(s) at the module of a processing unit, parameters not arriving or only arriving after a pre-specified time are rejected, whereby error handling is initiated for processing units with parameters not arriving or only arriving after expiry of a prespecified period.

In another embodiment of the invention, there is an arrangement to synchronize synchronously or asynchronously clocked processing units PRO₀, PRO₁ of redundant data processing systems, with the following features:

at least two processing units PRO₀, PRO₁ for processing identical instruction sequences,

peripherals MEM₀, MEM₁ assigned exclusively to the processing units for saving and/or exchanging data,

peripherals jointly usable by all processing unitsI/O₀, I/O₁, REG₀, REG₁, CMEM for saving and/or exchanging data,

the modules EQ₀, EQ₁ assigned to the processing units whereby the modules EQ₀, EQ₁ feature a unit to monitor transactions as well as a unit to stop the processing units until the current transaction has been reached by the processor units as well as a unit L₀, L₁ to transfer parameters of the transactions to other modules.

The modules EQ₀, EQ₁ can, in this case, feature a unit to synchronize the processing units, in particular on the basis of the following transactions:

non-cacheable memory transactions relating to a local memory MEM₀, MEM₁ assigned to the relevant processing units PRO₀, PRO₁ and/or

input/output transactions for input/output modules I/O₀, I/O₁ and/or

memory-mapped input/output transactions for external registers REG₀, REG₁ and/or

non-cacheable memory transactions relating to a common memory CMEM of processing units PRO₀, PRO₁.

In this case, the modules advantageously feature a unit to form the following parameters representative for transactions:

input/output addresses and/or

memory addresses and/or

data to be transferred and/or

type of transaction and/or

a signature formed from the input/output addresses and/or the memory addresses and/or the data to be transferred and/or the type of transaction.

For handling external events, for example, interrupts, the processing units advantageously have the following features:

at least one execution unit EU,

at least one instruction counter element CIC to count the instructions executed by the execution unit since the last change into a special operating mode,

at least one register element MIR, for which the content can be specified by instructions or is able to be fixed,

at least one comparator element K to switch over the execution unit EU into the special operating mode in response to the instruction counter CIC matching the register element MIR, whereby in special operating mode the buffered external events to be routed to the processor modules which influence the processor modules are called by the processor modules.

The buffered external events can be called advantageously in this case using software, firmware, microcode or hardware.

One advantage that can be seen in this approach is that it allows the use of all kinds of new or existing software on a hardware fault-tolerant platform, whereby a processing unit which supports the invention can be used in this platform without there being a requirement for clock-synchronous, deterministic operation of the CPU.

Further benefits are:

The processing units which are redundant to one another, typically made up of a CPU, a Northbridge and local memory, do not have to be operated coupled in strict phases.

The CPUs do not have to be identical, which especially allows the simultaneous use of different CPU steppings within a redundant system, and can be operated with different clock frequencies.

The CPUs can behave in different ways with regard to speculative execution of instructions.

Different CPU-internal execution times of identical CPUs, e.g. as a result of corrections after the appearance of alpha particles which corrupt the data merely lead to the synchronization events being reached at slightly different points in time.

The problems described in ensuring a clock-synchronous, deterministic method of operation lead, as a result of the imprecise timing of future CPUs, to instruction execution that cannot be correlated exactly. Since the CPU for a typical application must react to external events, e.g. to an interrupt generated by a peripheral or to data written by a device into memory, should be ensured that the CPU is made aware of these events at identical points in the instruction execution, since otherwise the evaluation of these events could lead to different program execution sequences of redundant CPUs.

The present invention provides that external events relevant to the execution of the program, such as for example interrupts or data generated by external devices, is presented to redundant CPUs at identical points in the instruction execution and thereby that the lockstep operating mode can be emulated.

In addition, output events of redundant CPUs that are presented at identical points in the instruction execution sequence are compared and the results thus evaluated. By contrast to the known methods which bring about the synchronization and distribution of data from the processor periphery by software-based methods, this method is implemented by the invention using hardware. Another advantage in this case is that the effect on performance is many times less than with software-based methods. In addition the described procedure is fully transparent for the application and operating system software, i.e. existing application and operating system software can continue to be used without modifications.

### BRIEF DESCRIPTION OF THE DRAWINGS

Exemplary embodiments of the invention are explained in more detail below in conjunction with the Figures.

FIG. 1 shows two processing units with assigned periphery and synchronization of transactions.

FIG. 2 shows two processing units that are synchronized by two modules on the basis of their peripheral transactions.

FIG. 3 shows the layout of a preferred processing unit with further details.

FIG. 4 shows a timing diagram of the instruction processing of two differently clocked processing units and their synchronization in accordance with the invention.

### DETAILED DESCRIPTION OF THE INVENTION

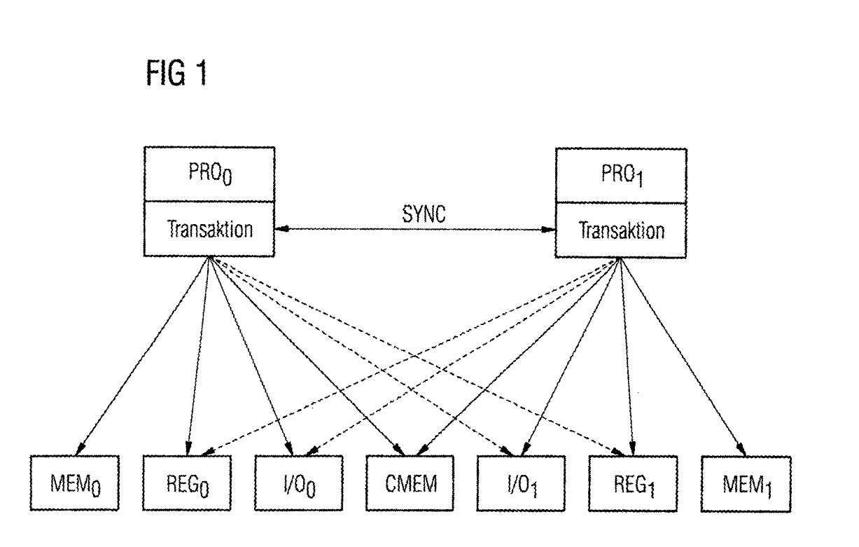

In FIG. 1, two processing units PRO₀, PRO₁ are shown schematically for which the external transactions are synchronized. Transactions for the following components are shown as examples: local memory MEM₀, MEM₁, registers REG₀, REG₁ and input/output modules or I/O modules I/O₀, I/O₁. In this case, the first processing unit PRO₀ is assigned the first components MEM₀, REG₀ and I/O₀ whereas the second processing unit PRO₁ is assigned the second components MEM₁, REG₁ and I/O₁. As shown by the corresponding dashed line connections the processing units have access to the registers REGₙ and the I/O modules I/Oₘ of the other processing unit in each case, whereas the assigned processing unit PROₖ has access to the local memory MEMₖ.

Furthermore, a typical component to which the processing units have common access is shown, here the common memory CMEM, whereby, by contrast to the registers and the I/O modules, the common memory is not assigned to either of the processing units.

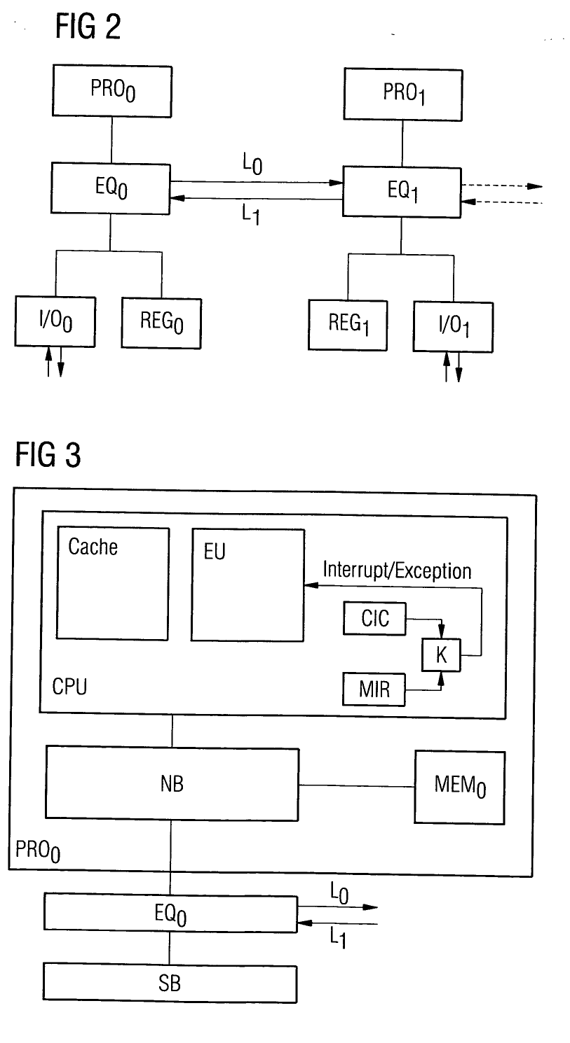

FIG. 2 shows two processing units and typically the I/O modules as well as the registers from FIG. 1. These are not conventionally connected directly via the corresponding interfaces or interface modules, but by means of equalizer modules EQ₀, EQ₁. Accesses by processing unit PRO₀ are received by the equalizer EQ₀, processed and forwarded accordingly, likewise the processing unit PRO₀ is presented with external data and events by the equalizer EQ₀. Similarly the processing unit PRO₁ is assigned an equivalent equalizer EQ₁.

The equalizers EQ₀, EQ₁ exchange information and for this purpose advantageously feature a fast and direct connection L₀, L₁. This connection can, as shown, be divided logically and/or physically into a first connection L₀:EQ₀→EQ₁ and a second connection L₁:EQ₁→EQ₀.

As shown in FIG. 2 by dashed lines, in accordance with the present invention, further units consisting of a processing unit PRO, an equalizer EQ and peripherals REG, I/O can be connected to form a corresponding system with multiple redundancy. Adding a further unit of this type would produce a triple redundancy system in which error handling can already be performed by a two out of three multiple decision.

FIG. 3 shows a more detailed implementation of the invention in conjunction with a conventional processor/periphery architecture with the outstanding feature that a Central Processing Unit CPU is linked via a Northbridge interface unit NB to a Southbridge interface unit SB, whereby the Northbridge for example also includes the interface with the local memory MEM₀ while the Southbridge typically comprises an interrupt controller and other I/O functions.

As shown by way of example in FIG. 3, a processing unit PRO₀ can be constructed from a CPU, a Northbridge and local memory. The CPU in a particularly advantageous embodiment can, as well as the conventional units, of which for the sake of simplicity only a cache memory and an execution unit EU are shown, also include a register MIR, a counter CIC and a comparator K which serve to forward external events as interrupts and exceptions to the execution unit at specific points in the instruction execution sequence and to guarantee an otherwise uninterruptible processing sequence for the instructions.

The equalizer module EQ₀ in accordance with the invention is preferably located between the Northbridge and Southbridge since the interface between the Northbridge and Southbridge features all the necessary signal lines to allow the equalizer to comply with the processing of the instruction sequences until the synchronicity of the processing unit PRO₀ with adjacent processing units (not shown) is achieved. The connections L₀, L₁ for connecting the equalizer EQ₀ to equalizers of adjacent processing units are only indicated.

The logical grouping shown in FIG. 3 does not necessarily correspond to the physical grouping of the individual components. For example, the Northbridge can be integrated into the CPU or the equalizer can be integrated into the Northbridge or the Southbridge or be with the Northbridge in the CPU.

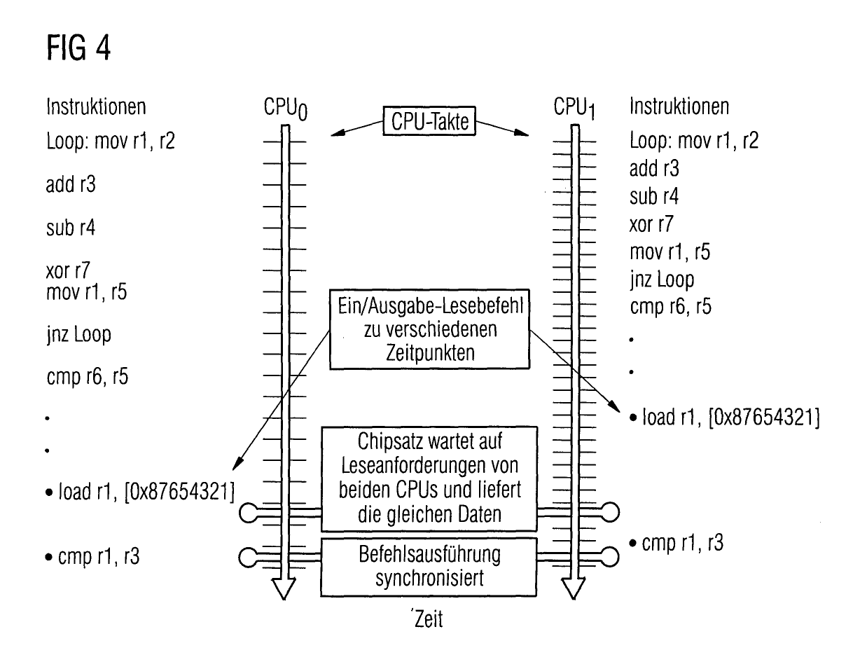

FIG. 4 is a graphic representation of the synchronization of the instruction execution of two processing units in the form of a timing diagram. In the example shown in FIG. 4, identical instruction sequences are processed by two CPUs CPU₀ and CPU₁, in which case CPU₀ is operated at a lower clock rate than CPU₁. This means that CPU₁ reaches each instruction at an earlier point than CPU₀, provided that at the beginning, i.e. on processing of mov r1, r2, the registers and the memory assigned to the CPUs were synchronized.

This non-synchronous instruction processing is tolerable as long as the CPU does not interact with the outside world, for example by means of I/O modules or access to common memory. For transactions of this type, in the example of FIG. 4 the reading out of I/O-register 0x87654321, it is however necessary for these transactions to occur simultaneously for both CPUs and especially with the same result. This is achieved using the equalizers, as described below. At the same time the equalizers ensure at such transaction points that the synchronicity of the CPUs is restored.

In line with the lockstep operating mode previously mentioned, the inventive method is called emulated lockstep below. An implementation for the emulated lockstep consists of at least two processing units PRO₀ and PRO₁ which can comprise a CPU, memory and memory control device (Northbridge of a standard chipset). The construction of these processing units is identical but they can feature different CPUs or different steppings of a CPU and are started in an identical state, i.e. identical memory and CPU register contents. Linkage via common or synchronized clocks is not required in accordance with the invention.

As part of the machine code instruction sequence the CPUs initiate memory cycles, for example write cycles, read cycles and if necessary I/O cycles. The cycles that fulfill the following conditions are suitable for synchronization of the CPUs:

(a) they are instruction deterministic, i.e. they will be issued identically by all CPUs at the same point in the program and in the same sequence, and

(b) they will be issued outwards by the CPUs, i.e. they are always visible and can be tapped outside the processors; processor-internal cache cycles are unsuitable for example

The following memory cycles fulfill these general requirements for example:

non-cacheable memory cycles in own memory MEM₀, MEM₁,

I/O cycles,

memory mapped I/O cycles, for example to external registers REG₀, REG₁,

non-cacheable memory cycles to a common memory CMEM.

Various external registers, e.g. timers, counters and/or an interrupt logic, as well as I/O units to the outside world, e.g. Ethernet controllers or SCSI controllers are generally in communication with the CPU. between CPU and I/O unit is an equalizer is connected for each CPU via an asynchronous or synchronous interface which implements the emulated lockstep operation. Asynchronous or synchronous point-to-point connections L₀, L₁ are required between the equalizers EQ₀, EQ₁ to enable data, addresses or signatures to be exchanged. At the asynchronous interfaces a repeat password of data transmission can be provided in the case of transmission errors.

Read or write data access to I/O units or registers is undertaken as memory mapped I/O or direct I/O. The I/O units are visible and accessible via separate memory addresses. By contrast the registers can be connected in a master-master or a master-slave configuration. With the master-master configuration the registers of the relevant assigned processing unit are accessed for reading or writing. A requirement for this mode of operation is that registers are in the same state when accessed by the processing units, in order to guarantee the parallel operating mode of the units.

With the master-slave configuration the units exclusively read the registers of the master unit and the registers of the master unit are written to by the master unit. For example, to read out the current time from the units, the Time-of-Day counter (ToD) of the master unit is used to ensure that the units are supplied with exactly the same time when the ToD counter is read out, i.e. the registers assigned to one processing unit are accessed. Events such as interrupts that occur at other units are then transferred to the master unit. Write access into these registers take place on the units or be stored in memory in shadow registers to enable processing to continue with the new master unit in the event of an error. This can be controlled either using software or hardware.

Individual transactions and the synchronization processes that take place on the basis of these transactions are described below in more detail.

Read Transactions

The Read instruction of a CPU of a processing unit PRO reads data from an I/O unit. A Read instruction of this type is illustrated in FIG. 4, a typical such instruction is load r1, [0x87654321]. This instruction is generated by CPUs at the same point in instruction processing and is directed to a specific I/O unit, for example I/O₀, or a master register. The time of the Read instruction can however be different at the different CPUs. In FIG. 4 the given Read instruction reaches CPU₀ later than CPU₁.

The I/O address or memory address generated by the CPU and the attributes of the transaction, e.g. Memory Read or I/O Read or data length or a signature generated from address and attributes is sent by the equalizer connected directly to the CPU to other equalizers. When the equalizer which is connected to the addressed I/O resource detects that the Read request has been generated by CPUs is the actual read access executed. With master-slave configurations the read data is distributed to equalizers which then complete the Read instruction of the relevant connected CPU by forwarding the data to the CPU. The data can arrive at the CPUs at different times but this will not affect subsequent execution of the program.

Should the I/O address or signature differ for an equalizer, read access is either not executed and an error interrupt is generated, for example a non-maskable interrupt NMI to the CPU, or a majority decision, e.g. 2 out of 3 is made if the configuration involved has 3 available CPUs. The faulty unit will be disconnected and diagnosed.

To detect failures of individual units the read accesses are timed, i.e. the Read- instructions of CPUs are generated within a certain pre-specified time. If this period of time between the instructions is exceeded a timeout will be generated, the failed unit is disconnected and diagnosed.

Read accesses are processed in the sequence in which they arrive. No provision is made for overtaking.

Write Transactions

The Write instruction writes data into an I/O unit or a memory unit. This instruction is generated by CPUs at the same point in instruction processing and is directed to a specific I/O unit, for example I/₀. The time of the Write instruction can however be different at the CPUs.

The I/O address, the date and the signature typically generated by the CPU and the attributes or a signature calculated from them is sent by the directly connected equalizer to other equalizers. When the write request has been generated by CPUs and was validated by the equalizer is the actual write access executed.

Should the I/O address, the date and/or the attributes or the signature differ for an equalizer, write access is either not executed and an error interrupt is generated, for example a non-maskable interrupt NMI to the CPU, or a majority decision, e.g. 2 out of 3 is made, if the configuration involved has 3 available CPUs. The faulty unit will be disconnected and diagnosed.

To detect failures of individual units the write accesses are timed, i.e. the Write instructions of CPUs are generated within a certain pre-specified time. If this period of time between the instructions is exceeded a timeout will be generated, the failed unit is disconnected and diagnosed.

Write accesses are processed in the sequence in which they arrive. No provision is made for overtaking. It is, however, possible for a number of write cycles to be created by the CPU (known as posted Writes). For the handling of these multiple write transactions an appropriately dimensioned first-in-first-out memory (not shown) can be provided.

Interrupts

The external events influencing the program execution sequence are not routed to the program directly, but first buffered by suitably designed hardware. In such cases this hardware can be a component of a module outside the CPU or a component of the CPU itself. The CPU includes a counter CIC (Completed Instruction Counter) which counts the machine code instructions which have been completed by the CPU. The CPU also includes a register MIR (Maximum Instruction Register), into which data is written by software supporting the emulated lockstep operation (ELSO).

The CPU further features a comparator K which compares the number of executed instructions, that is counter CIC, with register MIR and, if they are the same, typically generates an interrupt request which interrupts instruction execution after the number of instructions specified by register MIR and switches the CPU into another operating mode. In this operating mode suitable microcode is executed for example or a branch is made to an Interrupt Service Routine or hardware signals are used to show that this synchronization point has been reached. In this operating mode, the external events are then presented to the redundant CPUs such that, after leaving this operating mode, CPUs can evaluate these events in the same way and thereby execute the same instructions as a result.

Typically the CPU branches after reaching the number of machine instructions specified in register MIR to an Interrupt Service Routine, in which the state of the interrupt signals kept away by the described hardware of the CPU is interrogated so that a redundant CPU which if necessary makes this request at a slightly later point in time, receives identical information. This interrogation is, for example, a read data access to an interrupt register. This read access is handled as described above, which ensures that CPUs read the same interrupt vector and initiate the same actions.

Before the special operating mode is quit, counter CIC is reset. Subsequently, a branch is made back to the point in the program at which the interrupt occurred as a result of the counter value CIC specified in register MIR. The CPU will then again execute the number of machine instructions specified by register MIR and when counter CIC reaches register value MIR, will change the mode and thereby allow external events to be accepted.

For example, ELSO software that supports the emulated lock-step operation can set register MIR to a value of 10,000. A CPU which is operated with a 5 GHZ clock frequency and on average executes one machine instruction per clock (length of a clock:1/200 ps) would thus be interrupted in its instruction processing after 2 μs and allow synchronization with external events.

Direct Memory Access DMA

With a DMA transaction (Direct Memory Access) an I/O unit can have direct read and write access to memory. The timing relationship of an access of the I/O unit and CPU is not given. Were the CPU to access the same memory area during a DMA transfer, processing units could lose the pseudo-synchronous mode of operation since the main memory of the processing units is no longer necessarily identical at the time of access.

For a DMA transaction it must therefore be ensured that a notification is sent to the CPU which arrives at CPUs at the same point in the instruction execution. A number of solutions are demonstrated for this below.

For example, the notification can be sent by the I/O unit generating an interrupt after completion of the DMA transfer which tells the CPU that the transfer is completed and that the transferred memory area is released again. As a result of the interrupt the interrupt status of the source, that is of the I/O unit is read. This reading via the I/O bus of both units, e.g. the PCI bus, forces a serialization of the transactions, so that a guaranteed sequence of data generated by the I/O units is located in the memory of processing units.

In another embodiment, when jobs generated by the CPU of a processing unit are transferred to the I/O units by the CPU, an entry can be made in the register which initiates a DMA transfer. Alternatively, scripts or lists which are used simultaneously by both the CPU and the I/O unit can be located at the I/O unit as local memory. A possible data access from the CPU then takes the form of a memory mapped Read or Write instruction and it is ensured that CPUs operate with the same data.

In the other direction, when a descriptor generated by the I/O unit or the I/O units for the job for the CPU is to be in the memory of a processing unit PRO and is read out from the CPUs with a polling procedure, the CPUs read what is known as an I/O lockout register. Subsequently, at least no write transactions of the I/O units are sent by the equalizer into the local memory of the processing units PRO and the last write transactions sent by the I/O units are written by the equalizer into the local memory of the processing units. The verb frequently used for this process is “to flush”. It ensures the same content in the memories of the processing units in relation to write transactions generated by I/O units. Subsequently, the memory location in the memory of CPUs is read for which the value shows the completion of an I/O job, for example. Thereafter, the I/O lockout register is read or written again and an I/O-free register is read or written to allow write access to the main memory by the I/O units once again.

In a further embodiment, the following method can be used when the descriptor of the job generated by the CPU or the CPUs for the I/O units is to be in the memory of the PRO and is to be read out using a polling procedure: The CPUs read what is known as an I/O lockout register. Subsequently, at least no more read transactions of the I/O units are sent to the memory of the processing unit. Subsequently, a value is written into the memory location in the main memory of CPUs which represents a trigger for an I/O-MISSION. The I/O lockout register is then read or written again or an I/O-free register is read or written to enable read access to the memory by the I/O units again.

Data Comparison

Data which is read by I/O units from the memory is read by equalizers from the memory of the connected processing units, completely or as a signature, and sent to the equalizers connected to the requesting I/O unit and compared by the latter. Alternatively, the other equalizers can also perform a comparison. If it is the same, the data is forwarded to the I/O unit. If a difference is detected, a majority choice is made if necessary, e.g. 2 out of 3, and the faulty unit is disconnected and diagnosed.

Data which is generated by the CPUs of the processing units is sent completely or as a signature to the equalizer connected to the destination I/O unit and compared by the latter. Alternatively, the other units can also perform a comparison. If it is the same, the data is forwarded to the I/O unit. If a difference is detected, a majority choice is made if necessary, e.g. 2 out of 3, and the faulty unit is disconnected and diagnosed.

Read requests generated by the CPUs of the processing unit, characterized for example by the read command, addresses and attributes are sent completely or as a signature to the equalizer connected to the source and compared by the latter. Alternatively, the other units can also perform a comparison. If the data is the same, the read transactions are executed and the data read is sent to the equalizers. If a difference is detected, a majority choice is made if necessary, e.g. 2 out of 3, and the faulty unit is disconnected and diagnosed.

With emulated lockstep read and write transactions of the CPU are not compared as regards their local memory MEM since this can be completely different, e.g. as a result of different speculative accesses of the CPUs or different cache behavior. To check the contents of memory areas of the different processing units PRO for equivalence a check must be made for example by a routining software at a point at which one can be sure that the memory contents in the faulty state are consistent and remain consistent for the duration of the checking. Memory checking itself can be undertaken by software, i.e. the software/CPU reads a memory area for example, generates a checksum and compares the checksums determined by the different processing units. Memory checks can, however, also be undertaken by hardware with facilities located in the equalizers reading the memory of the connected processing units, forming a checksum and making a comparison between themselves.

Multiprocessor Architecture with Shared Memory

The emulated lockstep operation is also suitable for synchronizing memory access by a number of processing units to a shared memory CMEM and comparing that data as described above, provided that the transactions satisfy the general conditions explained previously; that is non-cacheable memory transactions for example.

Thus it is possible in a further embodiment to define multiprocessor configurations that consist of a number of processors (with local memory) which can access a common memory CMEM. In this case, each processor unit is duplicated for reasons of redundancy and for error detection, i.e. a processor unit includes two identical processing units PRO (not shown) which perform tasks in parallel and among other things synchronize for access to common memory and in doing so perform a data comparison.

What is claimed is:

1. A method for synchronizing redundant processing units which are clocked synchronously or asynchronously, comprising:
providing an identical instruction sequence to each of the redundant processing units;
assigning a module to each of the processing units;
monitoring transactions that are external to the processing units via the modules; and
achieving synchronization by placing the processing units in a wait state via the modules until the processing units have reached a current transaction.

2. The method according to claim 1, further comprising transferring parameters by the modules via connections for synchronization of the processing units which are characteristic of the transactions.

3. The method according to claim 2, wherein executing a read transaction comprises:
leaving a processing unit in the wait state until arrival of data to be read via the module associated with the respective processing unit;
sending the parameters of the read transaction to the module connected most directly with a transaction destination;
at the module connected most directly to the transaction destination, receiving and comparing the parameters from other modules and locally created parameters;
executing the read transaction and distributing the read data to the modules upon determining that the parameters match; and
at each module, forwarding the read data to the assigned processing unit and enabling continuation of instruction processing.

4. The method according to claim 3, further comprising executing a data comparison to check the data integrity by reading data areas from main memories at regular intervals or on request and comparing the parameters of the read transactions, the comparison being made by at least one of the modules.

5. The method according to claim 2, wherein the executing a write transaction comprises:
leaving a processing unit in the wait state until a write process is completed via the module associated with that processing unit;
sending the parameters of the write transaction to the module connected most directly with a transaction destination;
at the module connected most directly to the transaction destination, receiving and comparing the parameters from other modules and locally created parameters;
executing the write transaction and acknowledging the write process to the modules upon determining that the parameters match; and
at each module, enabling continuation of instruction processing for the assigned processing unit.

6. The method according to claim 2, wherein external events are buffered, whereby stored external events are called in a special operating mode of the processing units for processing by at least one execution unit of the processing units and the processing unit enters the operating mode in response to fulfillment of a condition that is pre-specified by instructions or fixed in advance, and continuation of instruction execution is delayed by the modules until the processing units have ended the special operating mode.

7. The method according to claim 6, wherein a change to the special operating mode is made if comparator elements of the processing unit find a match between a counter element and register elements, whereby content of the register elements are specified by commands and are identical for the processing units and the counter element includes a number of instructions completed by the execution unit since the last change into the special operating mode.

8. The method according to claim 7, wherein the external events routed to the processing units initiate an event handling routine which begins with the read transaction of an event vector, whereby the read transaction is executed by the module assigned to the processing unit by leaving the processing unit in the wait state until arrival of the data to be read and sending the parameters of the read transaction to the destination linked most directly to the transaction, whereby the module linked most directly to the transaction destination receives and compares the parameters of the other modules and locally created parameters and, if they match, executes the read transaction and distributes the data read to the modules, where the modules forward the read data to the assigned processing units and initiate continuation of the instruction execution.

9. The method according to claim 1, further comprising providing a direct memory access for transmission of data from the memory to an input/output module through initiation of direct memory access by jobs generated by a processing unit being transferred to the input/output module by entry into a register.

10. The method according to claim 1, further comprising providing a direct memory access for transmission of data from an input/output module into memory, such that a descriptor generated by an input/output module is stored in memory and is read out by the processing units with a polling procedure,
reading a register in one of the modules by the processing units causing no more write transactions in the memory by input/output modules,
writing a last of the write transactions sent by the input/output modules by the modules into the memory of the processing units,
reading a memory location in the memory of the processing units for which a value shows completion of a direct memory access, and
reading or writing to the register or another register to permit write access to the memory by the I/O units.

11. The method according to claim 1, further comprising providing a direct memory access for transmission of data between input/output module and a memory,
reading a register in one of the modules by the processing units causing no more read transactions by the input/output modules permitted in the memory,
storing a descriptor generated by the processing units in the memory which can be read out by one or more input/output modules with a polling procedure,
reading or writing the register or another register to permit read access to the memory by the I/O units, and
reading a memory location in the memory of one or more input/output modules, for which the value indicates the beginning of a direct memory access.

12. The method according to claim 2, wherein fault handling is initiated by a module linked most directly to a transaction destination if a deviation from the parameters of the other modules and locally generated parameters are established.

13. The method according to claim 12, wherein the fault handling stops the transaction to be executed and starts a routine for detection of the faulty unit, the isolation and recovery of which to re-establish the synchronicity.

14. The method according to claim 12, wherein with N available processing units the error handling makes an N−M (M<N) out of N majority decision and deactivates a divergent processing unit.

15. The method according to claim 2, wherein failures of individual processing units are detected such that for a transaction beginning with an earliest availability of the parameters at the module of a processing unit, error processing is initiated for processing units with parameters that do not arrive or arrive after expiry of a pre-specified time.

16. The method according to claim 1, wherein at least one of the following transactions are used by the modules for synchronization of the processing unit:
non-cacheable memory transactions relating to a local memory assigned to a relevant processing unit,
input/output transactions for input/output modules,
memory-mapped input/output transactions for external registers, and
non-cacheable memory transactions relating to a common memory of processing units.

17. The method according to claim 2, wherein at least one of the following parameters of transactions are transferred by the modules via connections for synchronization of the processing units:
input/output addresses,
memory addresses,
data to be transferred,
type of transaction,
a signature formed from the input/output addresses,
the memory addresses,
the data to be transferred, and
the type of transaction.

18. An arrangement to synchronize synchronously or asynchronously clocked processing units of redundant data processing systems, comprising:
at least two processing units for processing identical instruction sequences;
peripherals assigned to each of the processing units for saving and/or exchanging data; and
peripherals jointly usable by the processing units for saving and/or exchanging data; and
modules assigned to each of the processing units, the modules including a first unit to monitor transaction, a second unit to stop the associated processing unit until a current transaction has been reached by the processor units, and a third unit to transfer parameters of the transactions to other modules.

19. The arrangement in accordance with claim 18, wherein the processing units include:
at least one execution unit,
at least one Completed Instruction Counter to count instructions executed by an execution unit since a last change into a special operating mode,
at least one register element, for which contents can be specified by instructions or is able to be fixed, and
at least one comparator element to switch over the execution unit into the special operating mode in response to the completed instruction counter matching register element, whereby in special operating mode buffered external events which influence the processor modules to be routed to the processor modules are called by the processor modules.

20. The arrangement in accordance with claim 18, wherein the modules include a fourth unit to synchronize the processing units, based on the following transactions:
non-cacheable memory transactions relating to a local memory assigned to a relevant processing unit,
input/output transactions for input/output modules,
memory-mapped input/output transactions for external registers, and
non-cacheable memory transactions relating to a common memory of processing units.

21. The arrangement in accordance with claim 18, wherein the modules include a fifth unit to form the following parameters representative for transactions:
input/output addresses,
memory addresses,
data to be transferred,
type of transaction, and
a signature formed from at least one of the input/output addresses, the memory addresses, the data to be transferred, and the type of transaction.
